(19) United States
(12) Patent Application Publication
(10) Pub. No.: US 2007/0112885 A1
(43) Pub. Date: May 17, 2007

(54) DISTRIBUTED TRANSACTION HISTORY MANAGEMENT SYSTEM

(76) Inventor: Jon Farr, Overland Park, KS (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/561,246

(22) Filed: Nov. 17, 2006

Related U.S. Application Data
(60) Provisional application No. 60/738,135, filed on Nov. 17, 2005.

(51) Int. Cl. G06F 17/30

(52) U.S. Cl. 707/202

(57) ABSTRACT

A data transaction history management system and method for tracking and modifying data records associated with data transaction records stored in a database linked to a server. The database includes a plurality of data transaction records that each corresponds to a particular data transaction. A user interacts with a graphical user interface shown on a display of a client computer to generate an undo transaction request identifying a particular data transaction record to undo. The undo transaction request is transferred from the client computer to a server computer via a communication network. An application executing on the server undoes a transaction associated with the identified data transaction record to obtain an original transaction record, and stores the original transaction record and a new data transaction record in the database.

### CROSS REFERENCE TO RELATED APPLICATION

This application claims priority to U.S. Provisional Application No. 60/738,135 filed on Nov. 17, 2005.

### FIELD

The present document relates to a management system, and more particularly to a management system for managing a plurality of data transaction records.

### BACKGROUND

Maintaining and supporting distributed enterprise applications has become extremely important for financial institutions due to the implementation of the Sarbanes-Oxley Act of 2002 and regulatory guidelines, such as SAS 70 and HIPAA. More specifically, it has become critical for companies to account for all interactions with sensitive data being managed by enterprise applications. With the increase in the number of potential devices that are capable of initiating transactions, companies need to be able to capture information specific to the type of transaction and the client computer that initiated the transaction. Along with viewing the transaction history the users also need the ability to undo transactions that relate to any type of modification to the data. Therefore, a functionality is needed to record transaction specific information in conjunction with device specific information, thereby allowing the users to manage and audit the transaction history of any transactions as well as the ability to undo those transactions.

### SUMMARY

In one embodiment, a computer-implemented method is provided for managing a plurality of data transaction records stored in a database linked to a server computer wherein each of the plurality of data transaction records corresponds to a particular data transaction, and wherein each of the plurality of data transaction records are created in response to a transaction request transferred from a client computer to the server computer via a communication network. The computer implemented method may include receiving, at the server computer, an undo transaction request from the client computer with the transaction request identifying a data transaction record to undo; undoing the identified data transaction; and storing a new data transaction record in the database with the new data transaction record corresponding to the undo data transaction.

According to another embodiment, a system for managing a plurality of data transaction records stored in a database is provided wherein each of the plurality of data transaction records corresponds to a particular data transaction. The system may include a client computer generating an undo transaction request with the undo transaction request identifying a data transaction record stored in the database to undo; a server computer linked to the client computer via a communication network for receiving the undo transaction request, wherein the server computer executes a transaction component to undo the identified data transaction and to create a new data transaction record with the new data transaction record corresponding to the undo data transaction; and wherein the server computer may execute a storing component to store the new data transaction record in the database.

Various embodiments of the Distributed Transaction History Management (DTH) system may provide users with the ability to view a transaction history for data included in a data management system, and to view information about the user and/or device that initiated a particular transaction. As used herein, the term “transaction” is used to mean the viewing of data or any modification to the data stored in the data management system. Other aspects of the DTH system may provide users with the ability selectively undo a particular transaction identified in the transaction history or selectively merge data stored in the data management system. Advantageously, a user of the DTH system can efficiently and easily identify a specific transaction involving a particular data record in a database, identify information about the client computer and user that initiated that transaction, and modify the effects of that transaction.

### BRIEF DESCRIPTION OF THE DRAWINGS

FIG. 1 is a simplified illustration of a suitable operating environment in which the DTH system may be implemented;

FIG. 2A is a simplified block diagram illustrating components of a client application that can be used in accordance with one implementation of the DTH system;

FIG. 2B is a simplified block diagram illustrating various data transactions available via a client application;

FIG. 3A is a simplified block diagram illustrating components of a DTH application in accordance with one implementation of the DTH system;

FIG. 3B is a screen shot of a graphical user interface that can be used to define security authorization data in accordance with one implementation of the DTH system;

FIG. 4A is a flow chart illustrating a method for viewing or selecting data transaction records stored in an application database in accordance with one embodiment of the DTH system;

FIG. 4B is a screen shot of a graphical user interface that can be used for viewing or selecting records in an application database in accordance with one implementation of the DTH system;

FIGS. 4C and 4D are screen shots of a data table storing data transaction records after a view or select transaction is complete;

FIG. 5A is a flow chart illustrating a method for inserting information into a database in accordance with one embodiment of the DTH system;

FIG. 5B is a screen shot of a graphical user interface that can be used for inserting records in an application database in accordance with one implementation of the DTH system;

FIGS. 5C and 5D are screen shots of a data table storing data transaction records after an insert transaction is complete;

FIG. 6A is a flow chart illustrating a method for updating information stored in an application database in accordance with one embodiment of the DTH system;

FIG. 6B is a screen shot of a graphical user interface that can be used for updating records in an application database in accordance with one implementation of the DTH system;

FIGS. 6C and 6D are screen shots of a data table storing data transaction records after an update transaction is complete;

FIG. 7A is a flow chart illustrating a method for deleting information stored in an application database in accordance with one embodiment of the DTH system;

FIG. 7B is a screen shot of a graphical user interface that can be used for deleting records in an application database in accordance with one implementation of the DTH system;

FIGS. 7C and 7D are screen shots of a data table storing data transaction records after a delete transaction is complete;

FIG. 8A is a flow chart illustrating a method for merging information stored in an application database in accordance with one embodiment of the DTH system;

FIG. 8B is a screen shot of a graphical user interface that can be used for merging records in an application database in accordance with one implementation of the DTH system;

FIG. 8 is a screen shot showing merge transaction records in a primary data table;

FIGS. 8D and 8E are screen shots of a data table storing data transaction records after a merge transaction is complete;

FIG. 9A is a flow chart illustrating a method for undoing an update transaction involving data records stored in an application database in accordance with one embodiment of the DTH system;

FIGS. 9B and 9C are screen shots of a data table storing data transaction records after an undo update transaction is complete;

FIG. 10A is a flow chart illustrating a method for undoing a delete transaction involving data records stored in an application database in accordance with one embodiment of the DTH system;

FIGS. 10B and 10C are screen shots of a data table storing data transaction records after an undo delete transaction is complete;

FIG. 11A is a flow chart illustrating a method for undoing a merge transaction involving data records stored in an application database in accordance with one embodiment of the DTH system;

FIGS. 11B and 11C are screen shots of a data table storing data transaction records after the undo delete transaction is complete;

FIG. 12A is a flow chart illustrating is a method for redoing an update transaction involving data records stored in an application database in accordance with one embodiment of the DTH system;

FIGS. 12B and 12C are screen shots of a data table storing data transaction records; and

Corresponding reference characters indicate corresponding elements among the several views. The headings used in the figures should not be interpreted to limit the scope of the figures;

### DETAILED DESCRIPTION

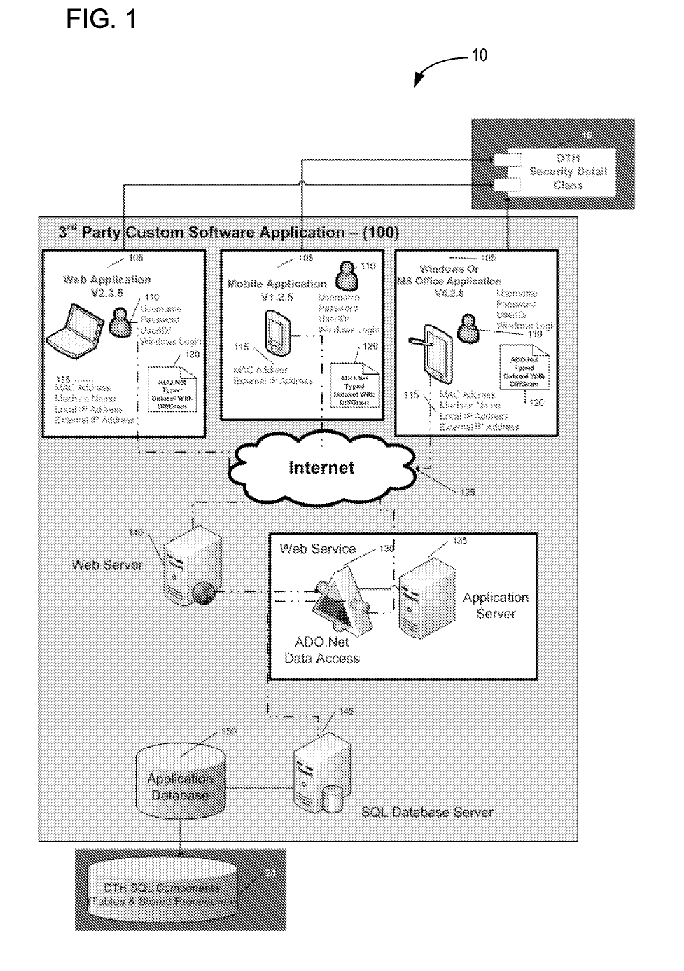

Referring to the drawings, a system and method for implementing a distributed transaction history management (DTH) is generally indicated as 10 in FIG. 1. As shown in FIG. 1, DTH system 10 may include a client computer 105 operatively coupled to a data communication network 125, which can be, for example, the Internet (or the World Wide Web). However, the teachings of the DTH system 10 can be applied to any data communication network 125.

An application server 135 and web server 140 are also operatively coupled to the data communication network 125. In turn, a user of the client computer 105 can access a web service 130, such as a data access service (e.g., ADO.Net Data Access) provided by the application server 135. The web server 140 may be an authentication server that contains or accesses information necessary to authenticate a user of the client computer 105 (as well as other users on the network) when the user attempts to access the web service 130 via application server 135. For example, the web server 140 may first request authenticating information from the user, such as the user's login ID and password. If the user is successfully authenticated, the web server 140 may then route client computer 105 to the application server 135 for performing a desired service for the user. In this example, data may be communicated between the web server 140, application server 135, and client computer 105 using the hypertext transfer protocol (HTTP), a protocol commonly used on the Internet to exchange information.

A database server 145, such as a structured query language (SQL) database server, may also be operatively coupled to the communication network 125, while an application database 150 may be operatively coupled to the database server 145. The application database 150 may include data records that are managed an DTH SQL components 20, such as stored procedures and tables. For example, the data records may be created via stored procedures and recorded in tables. Although the application database 150 is shown separately from the database server 145, it is to be understood that in other embodiments of the DTH system 10 the application database 150 may be contained within the database server 145.

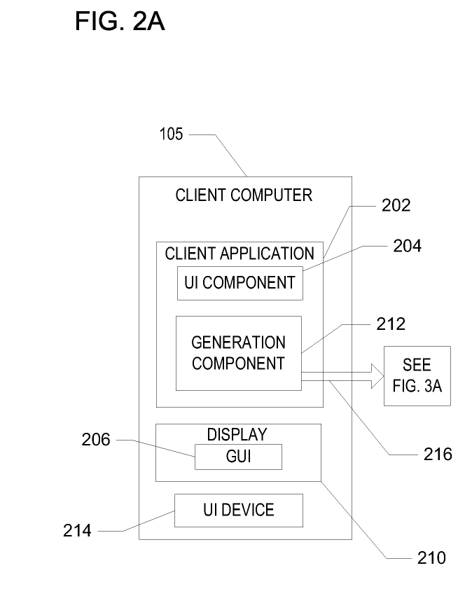

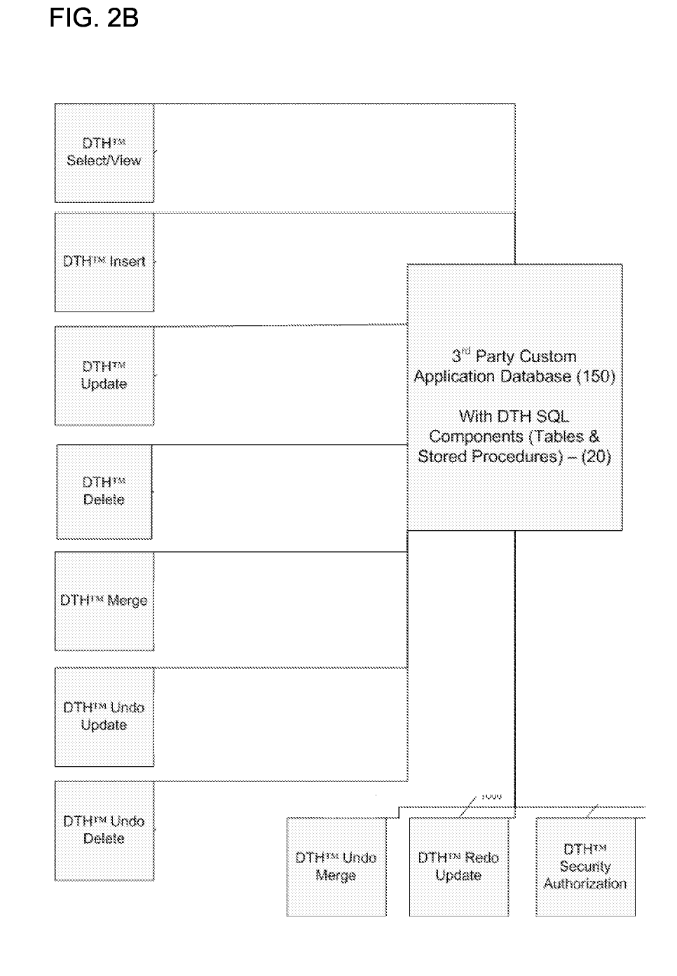

The client computer 105 may execute a third party application 100 configured for managing information in a relational database management system such as SQL database (e.g., application database 150). The third party application 100 can be a web application, a mobile web application, a smart device application, a Windows® or Microsoft Office® applications, or any other application that allows a user to perform data transactions. Data transactions can include viewing data, inserting data, updating data, deleting data, merging data, undoing data updates, undoing data merges, undoing data deletions, and redoing data updates, etc. The third party application 100 may provide a graphical user interface (GUI) or presentation layer that can be viewed on a display of the client computer 105 such that the user of the client computer 105 may interact with the GUI for the purpose of selecting a particular transaction to perform with DTH data stored in the application database 150. For example, user may interact with an input device (not shown) such as a keyboard or mouse to select a particular transaction that results in the creation or modification of DTH data. The third party application 100 is responsive to user input received via the GUI to generate a transaction request (FIG. 2A) that is communicated to the database server 145 via the communication network 125.

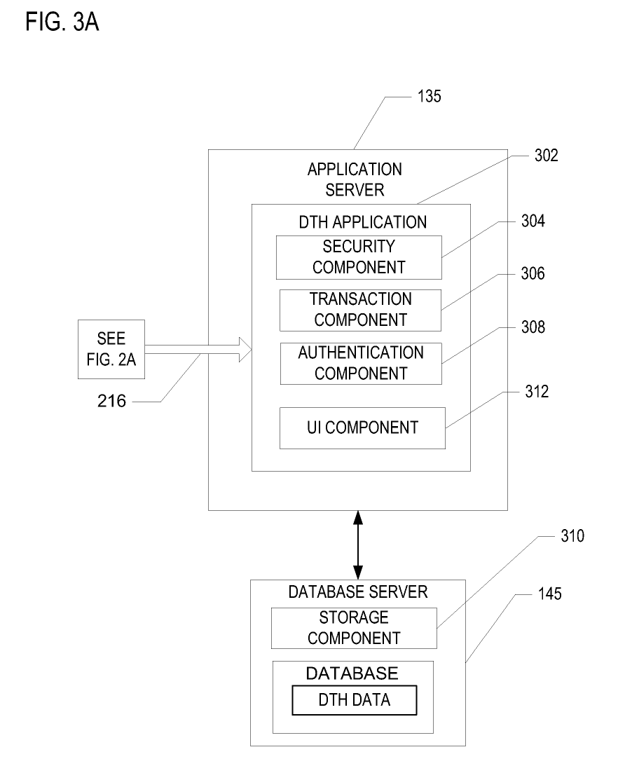

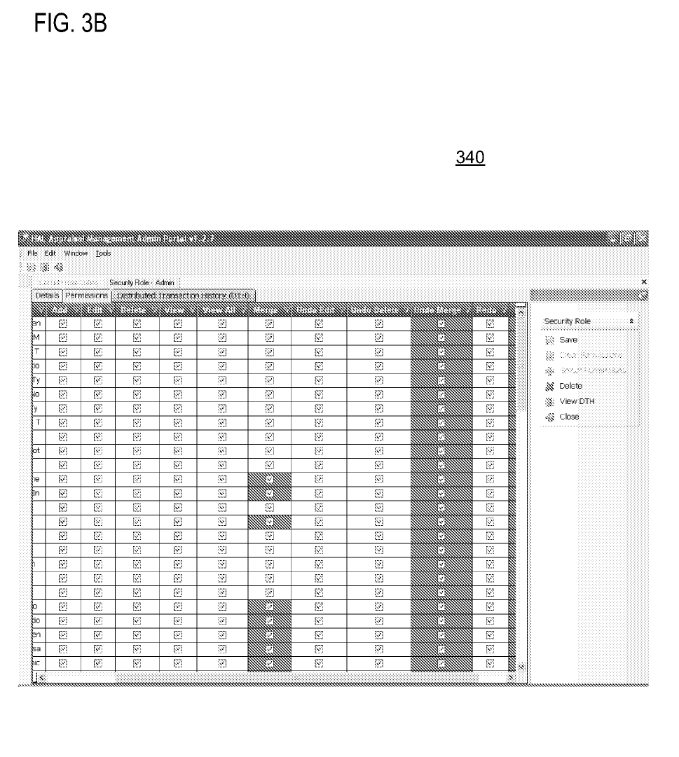

In one embodiment, the DTH system 10 executes a DTH application (FIG. 3A) to facilitate management of data records stored in the application database 150. The DTH application may create the DTH data record via stored procedures and records the created data record in a transaction table. The type of stored procedure used to create the DTH records depends on the type of transaction request received from the client computer 105.

The transaction request is then sent to the web service 130 using a data access program, for example ADO.Net, to communicate with the application database 150. The web service 130 may accept a typed dataset 120 and DTH security details 15 as arguments and passes this information to the application database 150 for processing. A typed dataset 120 provides access to the content of table fields through strongly typed programming that uses information from the underlying data schema. The DTH system 10 also captures device information 115 along with other specific information related to a particular data transaction, and passes this information along with each transaction initiated by the client computer to the application database 150.

The device information 115 uniquely identifies the type of the client computer 105 the user is operating to manipulate the data via the third party client application and includes, but is not limited to, the machine name of the computer, the MAC address of the network interface card, the local IP address of the computer used for the local network the computer is connected to and the external IP Address that is obtained by the outside firewall and is then communicated to external resources in the Internet. This device information 115 can be retrieved from a primary class library that is comprised of the DTH security class details 15 which stores the device information 115, third party application information 100, and user information 110. This primary class library can be integrated into the third party application 100.

The stored procedures combine the device information 115 with information related to the particular transaction for distribution to a corresponding transaction table. For example, information related to a merge transaction operation may be stored in a merge table. The information stored in a table can include a table name, field name, original value, new value, action, and the date and time for each modified field in a particular data table. The stored procedures are program instructions for storing, modifying, creating or deleting data records from tables stored in the application database 150, and as explained in more detail below, one or more stored procedures may be executed to perform a particular data transaction initiated by a user. A listing of exemplary stored procedures is provided in the attached appendices which are incorporated by reference in their entirety.

As a result, this distributed transaction history is available for viewing and can be accessed by users of the client computer 105. In addition, the distributed transaction history can be used to undo a particular transaction that involved a modification to the data or a deletion of the data. As a result, the DTH system 10 provides a user of the client computer 105 with an improved system and method for identifying a specific transaction for DTH data in a database, identifying information about that specific transaction, and allows the user to undo that particular transaction or merge transactions.

Referring to FIG. 2A, a block diagram illustrates the components of a client application 202 being executed on the client computer 105 to initiate a data transaction in accordance with one implementation of the DTH system 10. The client application 202 can be, for example, any third party application such as a web browser application that communicates with the application server 135 and database server 145 via the communication network 125 to receive data from the application database 150.

A UI component 204 of the client application 202 displays a GUI 206, such as an input form (not shown), on a display 210 of the client computer 105 that allows the user to select a particular transaction to perform with data records stored in the application database 150. For example, as shown by the block diagram illustrated in FIG. 2B, the user can select various transaction options such as view/select, update, delete, merge, undo update, undo delete, undo merge, or redo update.

A generation component 212 is responsive to input received from a user via a user interface (UI) device 214 communicatively connected to the client computer 105 in order to generate a transaction request, as indicated by reference character 216, to perform a particular transaction with respect to data stored or data to be stored in the application database 150. For example, the user of the client computer 105 uses a UI device 214, such as a keyboard or mouse, to interact with the GUI 206 shown on the display 210 to select a particular transaction option. Moreover, the generated transaction request 216 includes metadata that specifies the particular type of transaction selected by the user. For example, consider that the user has selected an update option from the GUI 206 shown on the display 210 of the client computer 105. The generated transaction request 216 will include metadata that identifies the transaction request as an update transaction request.

Referring to FIG. 3A, a block diagram illustrates the various components of a DTH application 302 being executed on the application server 145 that provides the data access web service 130 and that facilitates the transfer of DTH data to and from the application database 150. A security component 304 is responsive to a transaction request 216 received from the client computer 105 to identify device information 115 for the client computer 105 such as the client application name, User ID, internal IP address, Media Access Control (MAC) Address, and Machine Name. The device information 115 is transferred from the client computer 105 to the database server 145 along with the transaction request 216. More specifically, FIG. 1 illustrates the device information 115 is transferred from a primary class library, which is integrated into the third party custom software application 100, to the web service (i.e., data access layer 130).

Referring back to FIG. 3A, a transaction component 306 identifies specific transaction information included in the transaction request 216 such as the particular type of data transaction selected by the user. For example, the user may select an update option from the GUI shown on the display of the client computer 105. The transaction component 306 identifies the received transaction request 216 as an update transaction request 216 based on metadata included in the received transaction request.

An authentication component 308 associated with the web service 130 may be provided by the application server 135 for determining whether the user is authorized to perform the identified transaction. For example, the authentication component 308 may retrieve user information such as authorization data from the application database 150 and authenticates the transaction request 216 by comparing authentication data received from the client computer 105 along with the transaction request 216 to retrieved authorization data. The user information for the user that is logged into the web service 130 may include the user id, username and password for custom security. Alternatively, security information received from a DTH security detail class 15 associated with the client application 100 may be used to indicate whether the user is authorized to perform the requested transaction. FIG. 3B shows a screen shot of a GUI 340 provided by the client application that can be used to define the security authorization data that is included in the security class detail 15. If the user has authorization for the identified transaction, the authentication component 308 transfers the device information 115 and transaction information to the database server 145.

The database server 145 executes a storage component 310 to store the transferred the device information 115 and transaction information in the application database 150. More specifically, the database server 145 may execute stored procedures associated with the application database 150 to combine the device information 115 with information related to the particular data transaction initiated by the user for storage in the appropriate data table. As described above, information stored in the table can include the table name, field name, original value, new value, action, date and time for each modified field in a particular data table.

A UI component 312 transfers an acknowledgement to the client computer 105 that the transaction is complete, and/or transfers DTH data to the client application if the transaction request 216 involves the retrieval of DTH data.

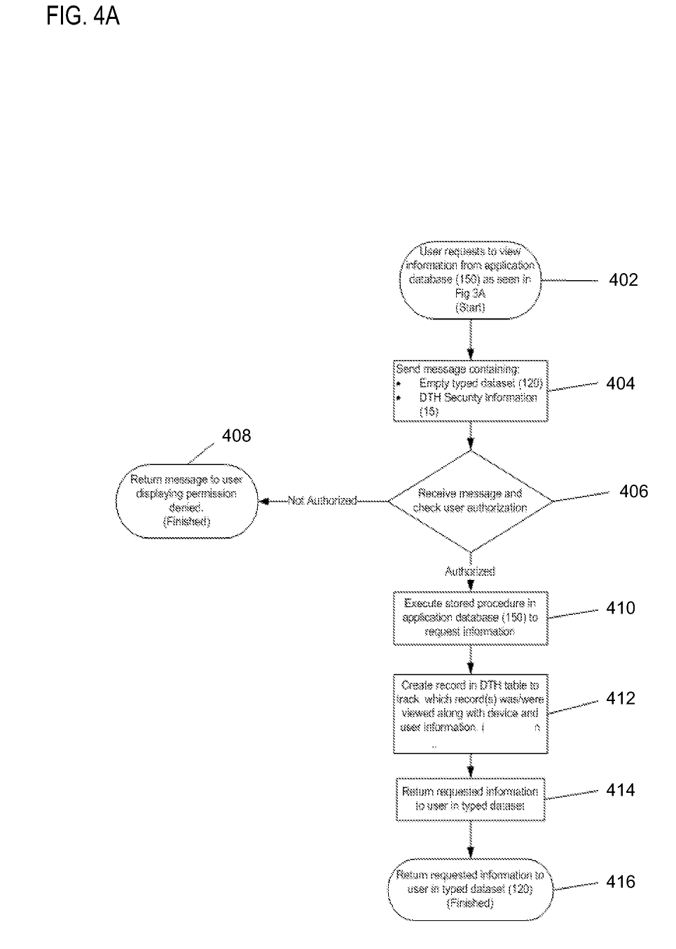

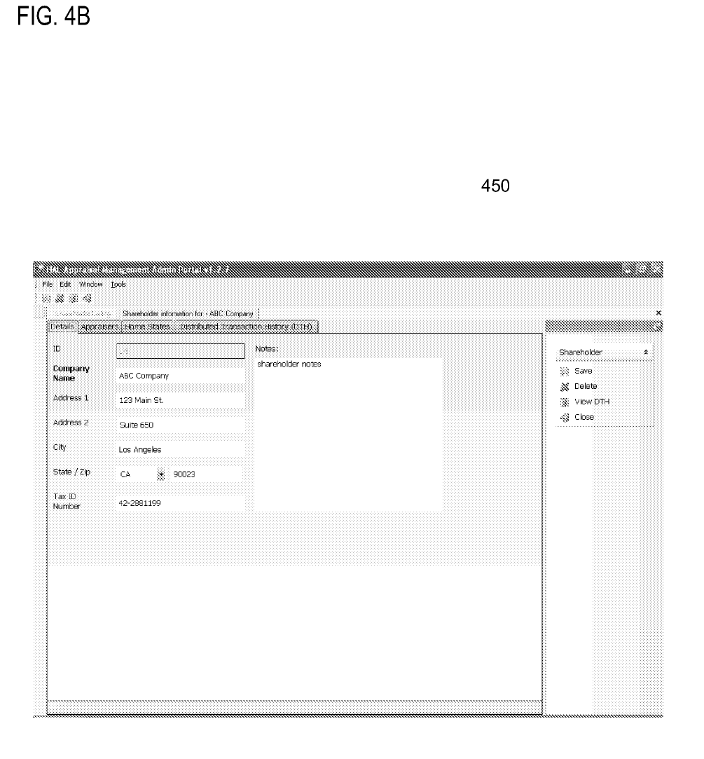

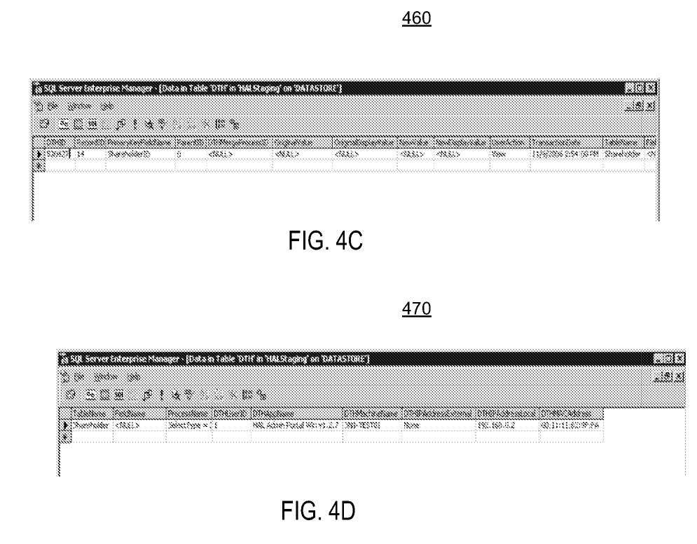

Referring to FIG. 4A, a method for viewing or selecting information from the application database 150 and presenting that information to the user on the client application 202 is illustrated. At step 402, the user interacts with a GUI 450 of a client application 202 to select a view/selection option to retrieve information from the application database 150 (FIG. 4B). A transaction request 216 is created that includes an empty typed dataset 120 along with DTH security details 15 and may be sent to the web service 130 to retrieve the selected information at step 404. At decision point 406, the web service 130 receives the transaction request 216 and determines whether the user has proper authorization to view the selected information. For example, the web service 130 authenticates the transaction request 216 as described above in reference to FIG. 3. If the user is determined to be unauthorized at decision point 406, the request to view the selected information is denied and a message indicating the denial is transferred to the client computer and shown on the display at step 408. Alternatively, if the user is determined authorized at decision point 406, the web service 130 communicates the DTH security details 15 to database 150 and the database server 145 executes the appropriate stored procedure to retrieve the information at step 410. (See Appendix A-1 for a listing of code that can be used to implement the stored procedures to retrieve the information in response to a view/selection transaction request). At step 412, the stored procedure used to retrieve the selected information may be used to execute the primary DTH stored procedure used to insert a record into the primary DTH table. (See Appendix A-2 for a listing of code that can be used to implement the stored procedures to into the primary DTH table, and Appendix A-4 for an example of the primary DTH table). The selected information retrieved by the application stored procedure is transferred back to the web service 130 and inserted into the typed dataset 120 at step 414. At step 416, the typed dataset 120 is transferred to the client application 202 and presented to the user via the view/selection GUI. FIGS. 4C and 4D are scroll left and scroll right screen shots 460, 470 respectively, showing the data records created for various fields after a selection or view transaction is complete.

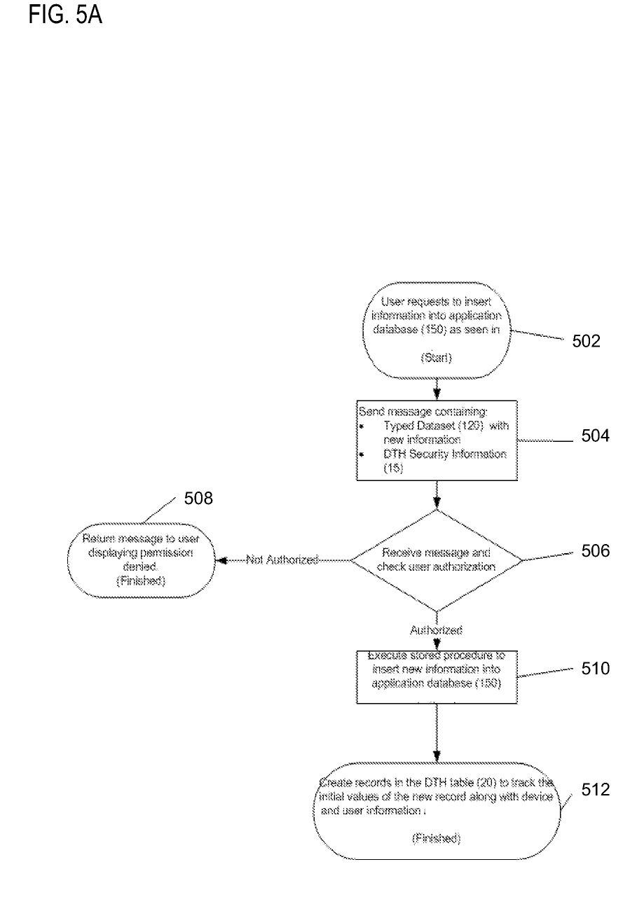

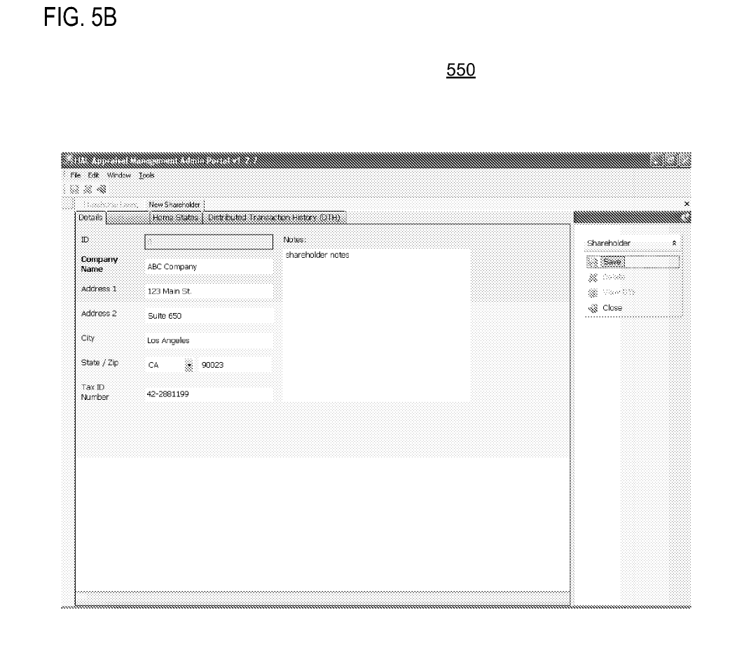

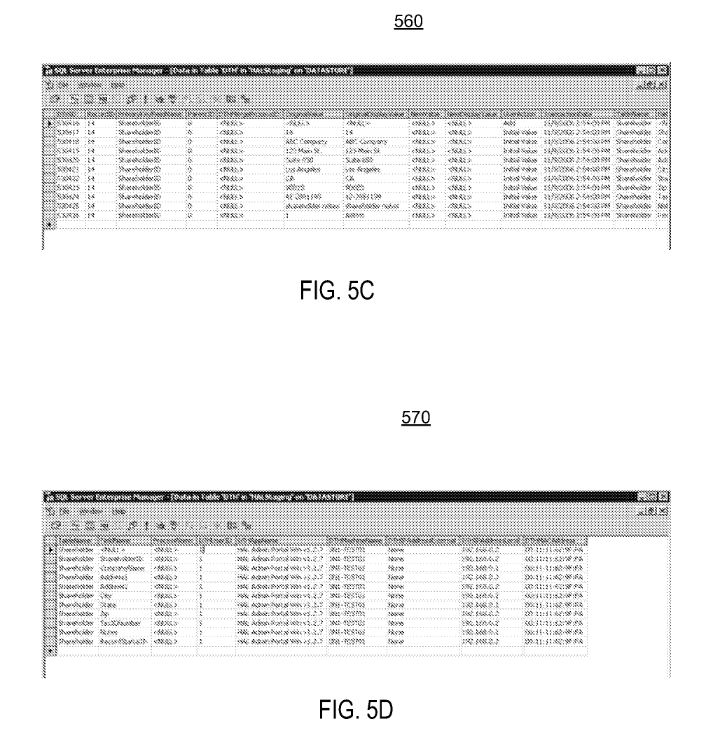

Referring to FIG. 5A, a method for inserting information into the application database 150 is illustrated. At step 502, the user initiates a process to insert information from the client application 202 into the application database 150. For example, the user may interact with a GUI 550 of a client application 202 to select an insert option to insert information into the application database 150 (FIG. 5B). An insert transaction request is generated and communicated to the web service 130 at step 504. The generated insert transaction request includes DTH security detail information 15 and a typed dataset 120 specifying the information to be inserted into the application database 150. At decision point 506, the web service 130 receives the insert transaction request and determines whether the user has proper authorization to insert information into the application database 150. If the user is determined unauthorized at decision point 506, the request to insert information is denied and message indicating the denial is transferred to the client computer 105 and shown on the display 210 at step 508. Alternatively, if the user is determined authorized at decision point 506, the web service 130 communicates with the application database 150 to pass the DTH security detail information 15 and executes the appropriate application stored procedure to insert the information into the application database 150 at step 510. (See Appendix at page A-8 for a listing of code that can be used to implement the stored procedures in response to insert transaction request). At step 512, the same application stored procedure used to insert the information may be used for executing a primary DTH stored procedure (e.g., see Appendix A-2) used to insert a record into a primary DTH table (e.g., see Appendix A-4 for an example of the fields and records in the primary DTH table) and executes an additional application stored procedure (e.g., see Appendix A-5) to create data records for the initial values of each field in the record that was inserted into the primary DTH table. FIGS. 5C and 5D 4D are scroll left and scroll right screen shots 560, 570 respectively, showing the data records created for various fields after in insert transaction is complete.

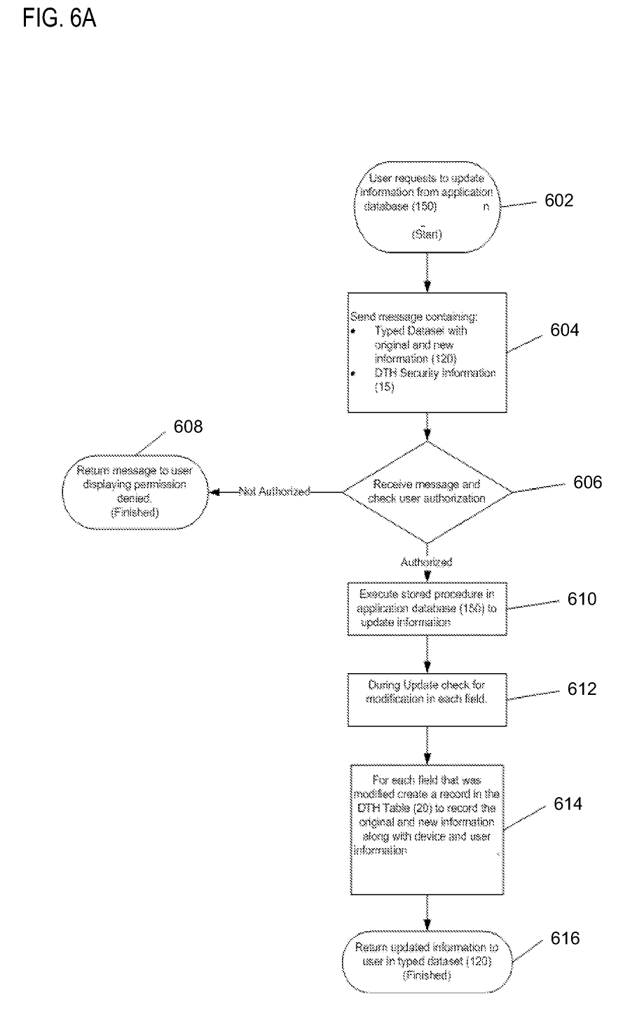

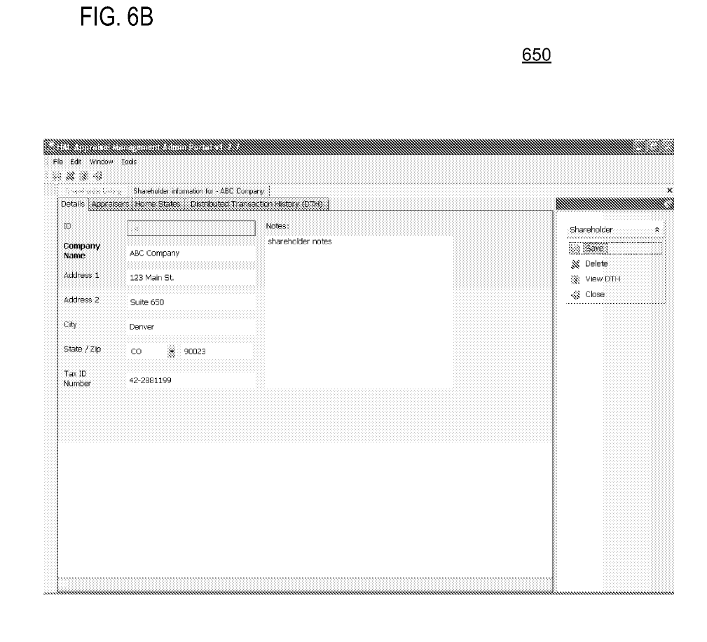

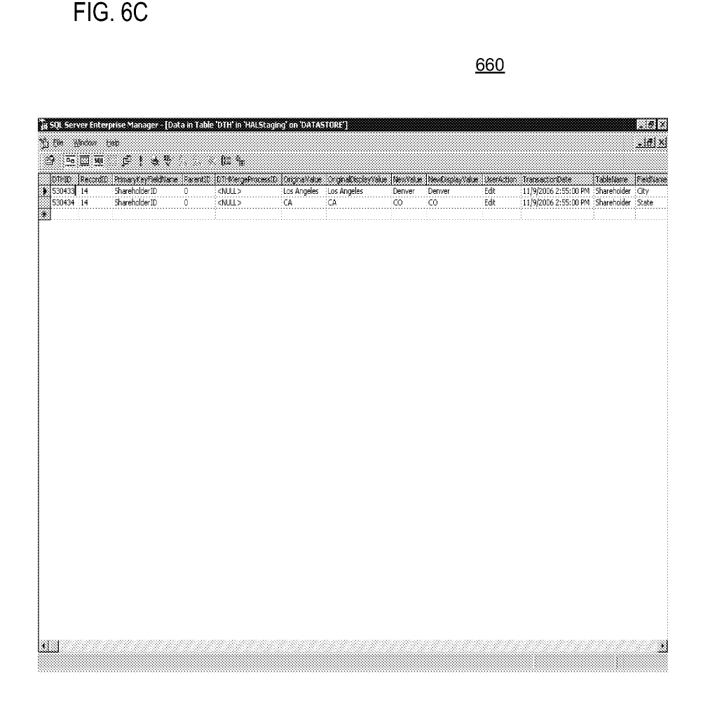

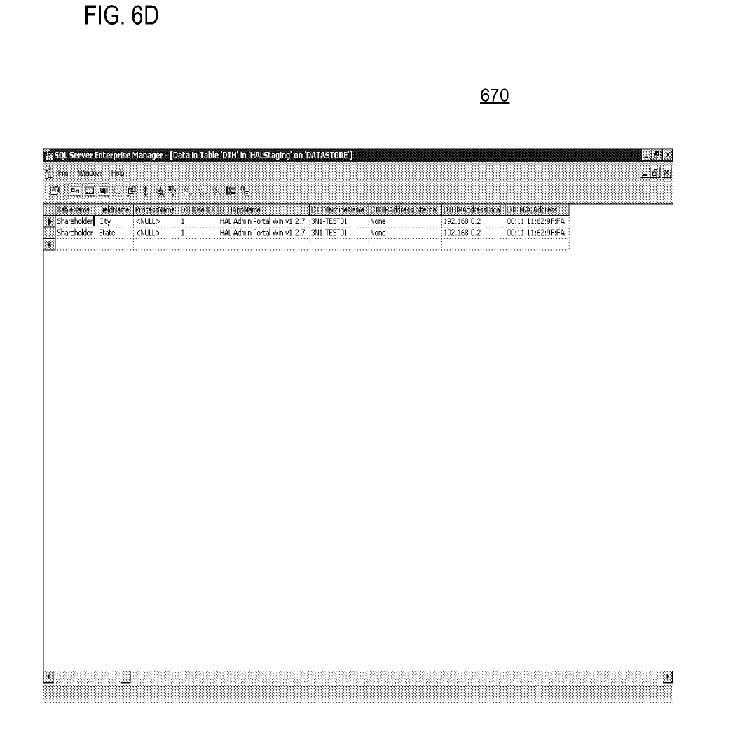

Referring to FIG. 6A, a method for updating information stored in the application database 150 is illustrated. At step 602, the user initiates the process to update information in the application database 150. For example, the user may interact with a GUI 650 of a client application 202 to select an update option to update or modify information stored in the application database 150. (FIG. 6B). An update transaction request is generated and communicated to the web service 130 to update information in the application database 150 at step 604. The update transaction request includes DTH security detail information 15 and a typed dataset 120 specifying the original version and the new version of the data record being updated. At decision point 606, the web service 130 receives the update transaction request and determines whether the user has proper authorization to update the information. If the user is not authorized to the update the request to update the information will be denied. If the user is determined to be an unauthorized user at decision point 606, the request to update information is denied and message indicating the denial is transferred to the client computer 105 and shown on the display 210 at step 608. Alternatively, if the user is determined to be an authorized user at decision point 606, the web service 130 communicates with the application database 150 to pass the DTH security detail information 15 and the typed dataset 120, and executes the appropriate application stored procedure 150 (e.g., see Appendix A-3) to update the information in the application database at step 610. At step 612, an update application stored procedure compares the original value and the new value of each field in the data record. (See Appendix A-6 for a listing of code that can be used to implement the update stored procedures). The update application stored procedure executes the primary DTH stored procedure (e.g., see Appendix A-2) for each field that was modified in the record and inserts a record into the primary DTH table at step 614. At step 616, the typed dataset 120 is transferred back to the client application 202 and presented to the user via the update GUI. (FIG. 6B). FIGS. 6C and 6D are scroll left and scroll right screen shots 660, 670 respectively, showing the data records created for various fields after an update transaction is complete.

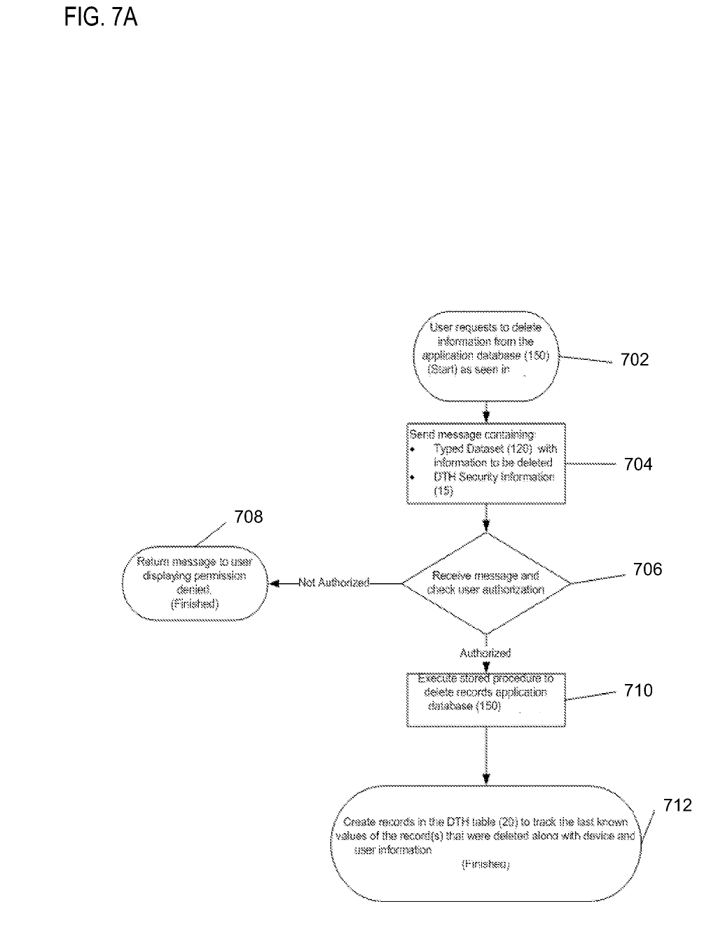

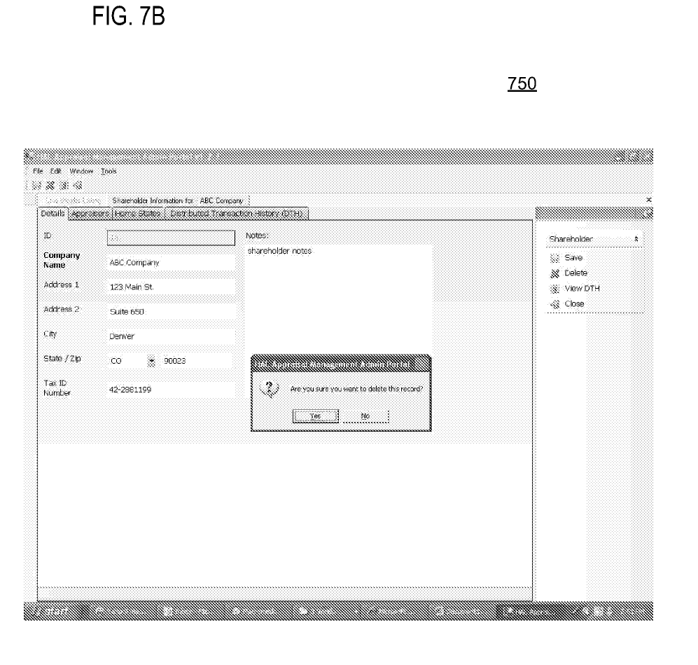

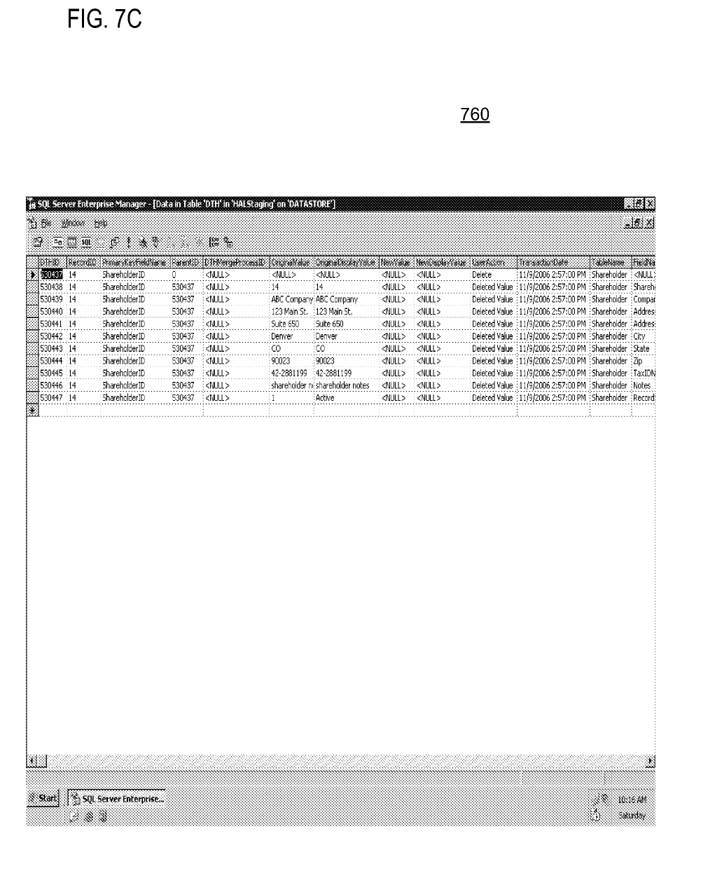

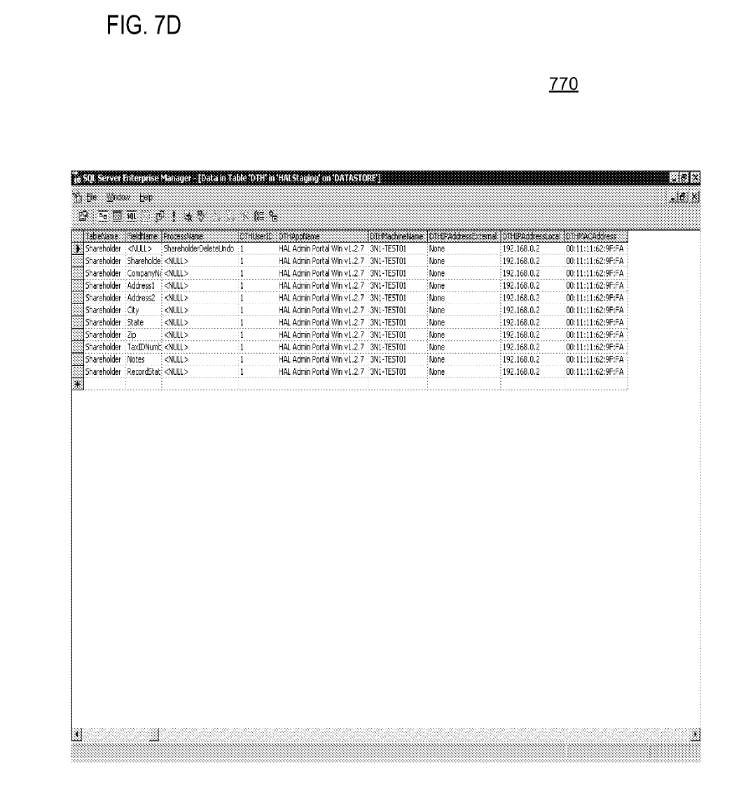

Referring to FIG. 7A, a method for deleting information stored in the application database 150 is illustrated. At step 702, the user initiates the process to delete information stored in the application database 150. For example, the user interacts with a GUI 750 of a client application 202 to select a delete option to remove information stored in the application database 150. (FIG. 7B). A delete transaction request is generated and communicated to the web service 130 at step 704. The delete transaction request includes the DTH security information 15 and a typed dataset 120 specifying the information to be deleted. At decision point 706, the web service 130 receives the delete transaction request and determines whether the user has proper authorization to delete the information. If the user is determined to be unauthorized at decision point 706, the request to delete information is denied and a message indicating the denial is transferred to the client computer 105 and shown on the display 210 at step 708.

Alternatively, if the user is determined authorized at decision point 706, the web service 130 communicates with the application database 150 to pass the DTH security information 15 and the typed dataset 120, and executes a delete application stored procedure to delete the information in the application database at step 710. (See Appendix A-7 for a listing of code that can be used to implement the delete stored procedures). At step 712, the delete application stored procedure executes the primary DTH stored procedure (e.g., see Appendix A-2) used to insert a record into the primary DTH table (see Appendix A-4) and executes a create application stored procedure to create records for the last known values of each field in the record that was deleted from the primary DTH table. (See Appendix A-8). FIGS. 7C and 7D are scroll left and scroll right screen shots 760, 770, respectively, showing the data records created for various fields after the delete transaction is complete.

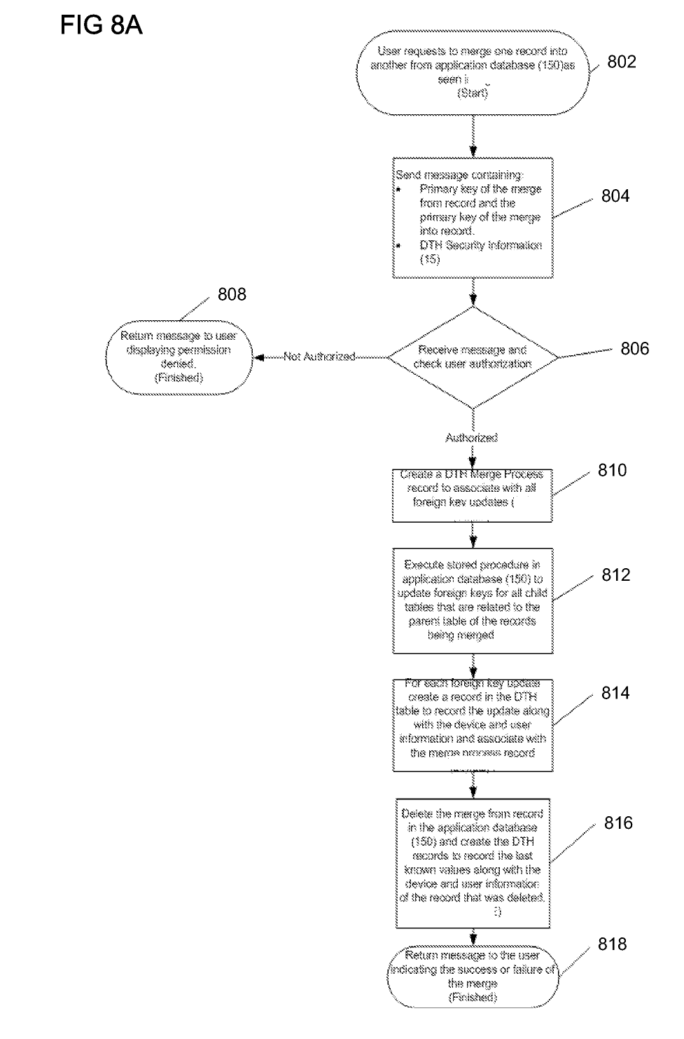

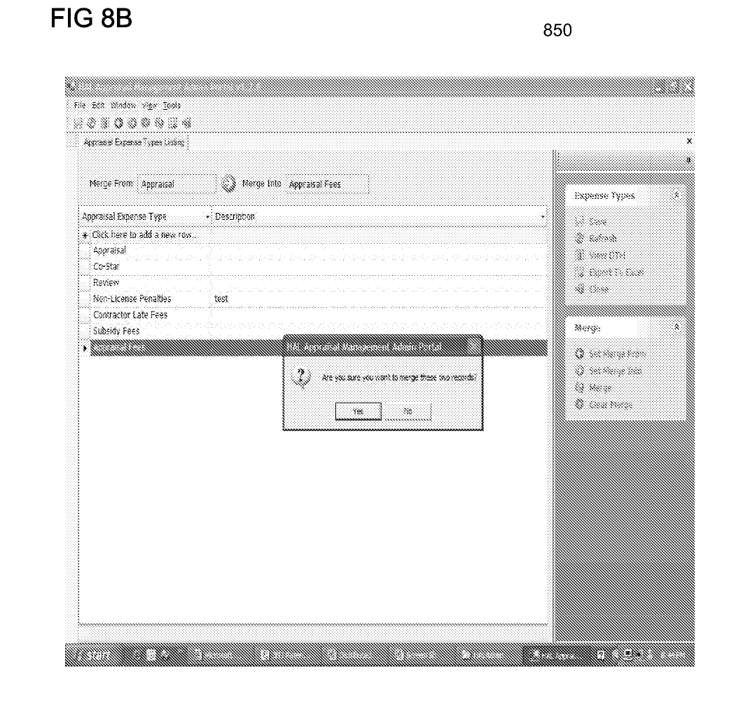

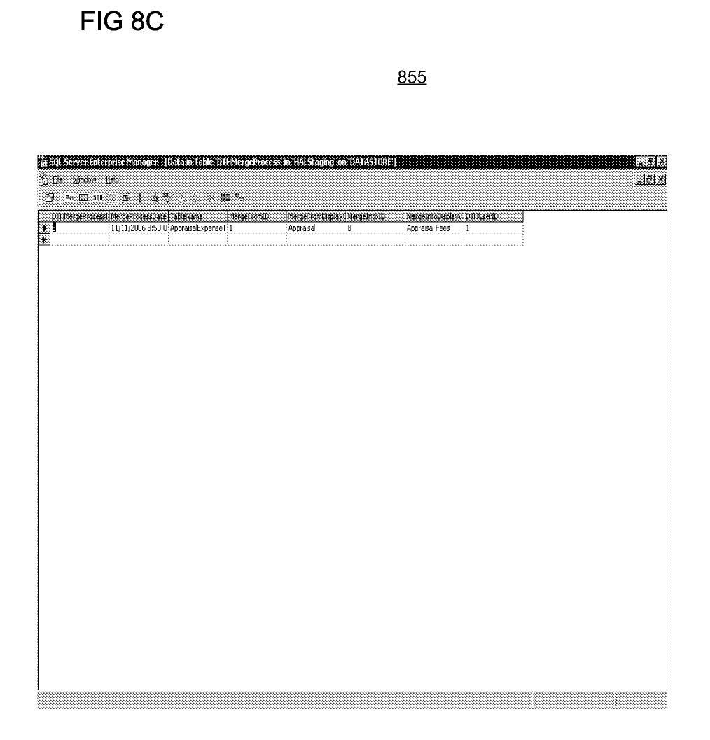

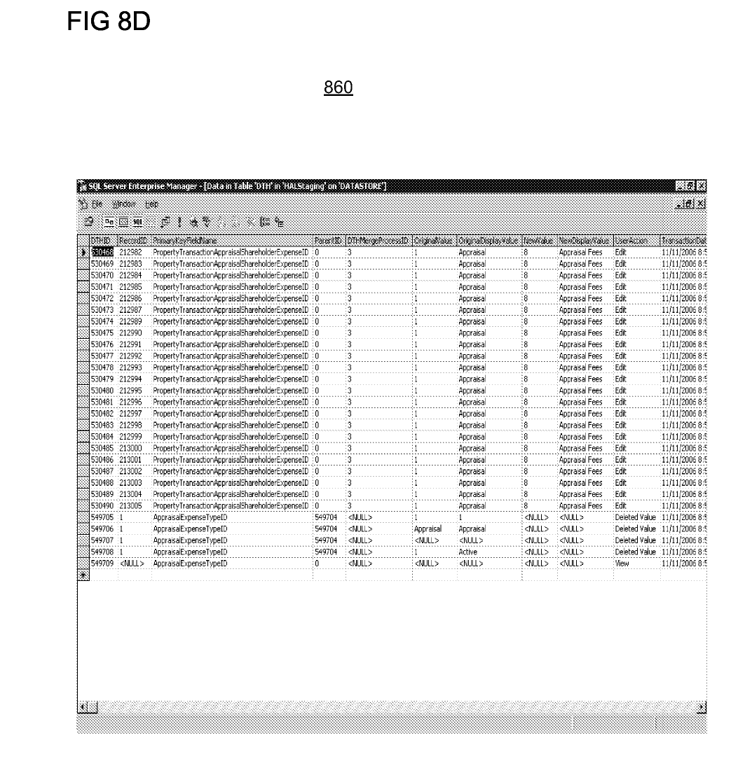

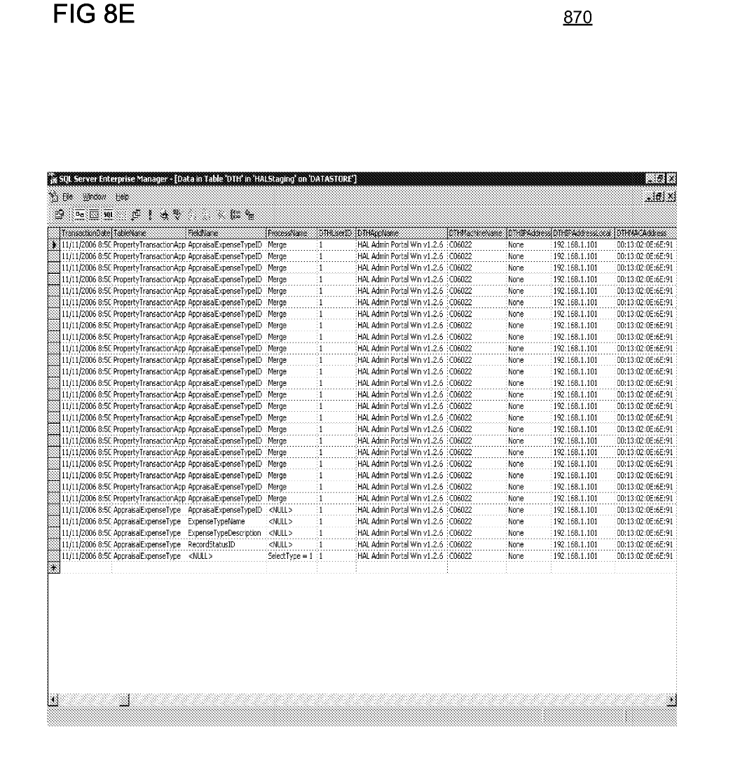

Referring to FIG. 8A, a method for merging information stored in the application database 150 is illustrated. At step 802, a user initiates a process to merge information stored in the application database 150. For example, the user interacts with a GUI 850 of a client application 202 to select a merge option to merge records stored in the application database 150. (FIG. 8B). A merge transaction request is generated and communicated to the web service 130 at step 804. The merge includes the primary key of the “merge from” record and the primary key of the “merge into” record along with the DTH security information 15, and is sent to the web service 130 to update the application database 150 at step 804. (See MergeFromID field and MergetoID field in Merge Table 855 in FIG. 8C). At decision point 806, the web service 130 receives the merge transaction request 216 and determines whether the user has proper authorization to merge information. If the user is determined to be unauthorized at decision point 806, the request to delete information is denied and a message indicating the denial is transferred to the client computer 105 and shown on the display 210 at step 808.

Alternatively, if the user is determined authorized at decision point 806, the web service 130 communicates with the application database 150 to pass the DTH security information 15 and the typed dataset 120 and executes the merge stored procedure (see Appendix A-7) to create a record in a merge table at step 810. (See Appendix A-11 for an example merge table and field definitions). At step 812, a merge application stored procedure (e.g. see Appendix A-10) is executed to merge and update the foreign key information. For each foreign key update, the primary stored procedure will be executed to record the update to the foreign key at step 814. (See Appendix A-2). At step 816, the application stored procedure used to update each foreign key executes the delete application stored procedure (e.g., see Appendix A-7) to delete the merge from a data record that was designated by the user as the record to be merged (“Merge From record”) into another record (“Merge Into record”).

The delete stored procedure used to delete the merge from record executes the primary DTH stored procedure (e.g., see Appendix A-2) to insert a record into the primary DTH table and executes the create application stored procedure (e.g., see Appendix A-8) to create records for the last known values of each field in the record that was deleted from the primary DTH table 150. A success flag value indicating true (e.g., flag value=1) or false (flag value=0) is communicated to the client application indicating the success or failure of the merge process at step 818. FIGS. 8D and 8E are scroll left and scroll right screen shots 860, 870, respectively, showing the data records created for various fields after the merge transaction is complete.

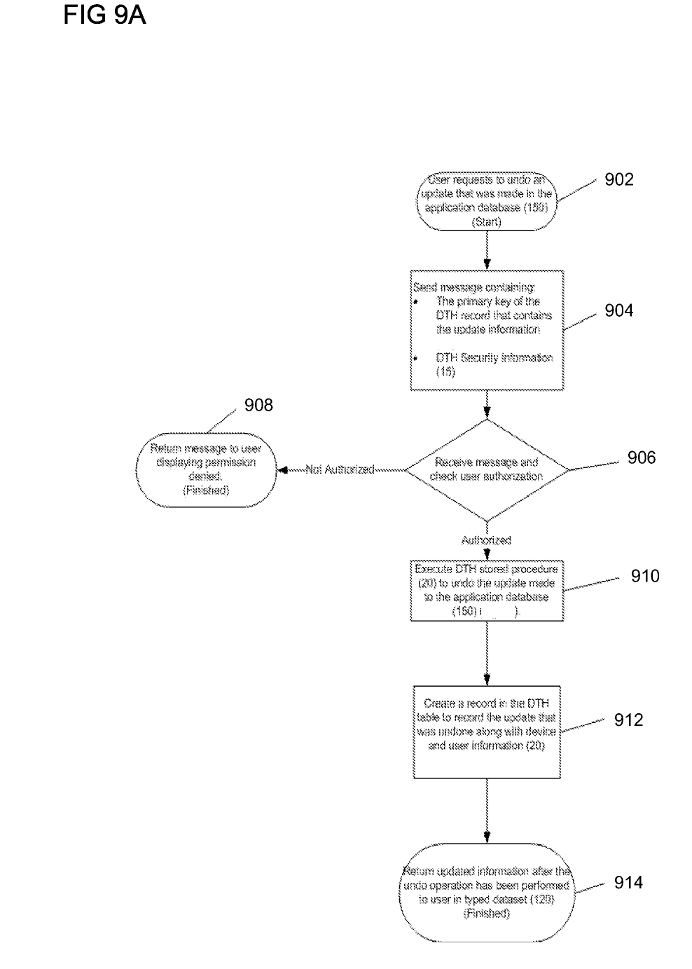

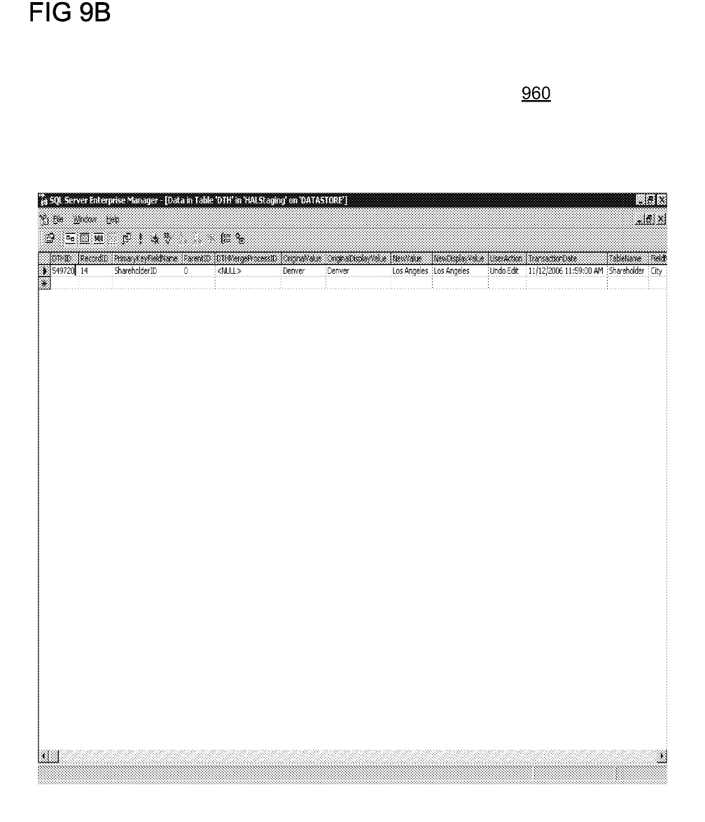

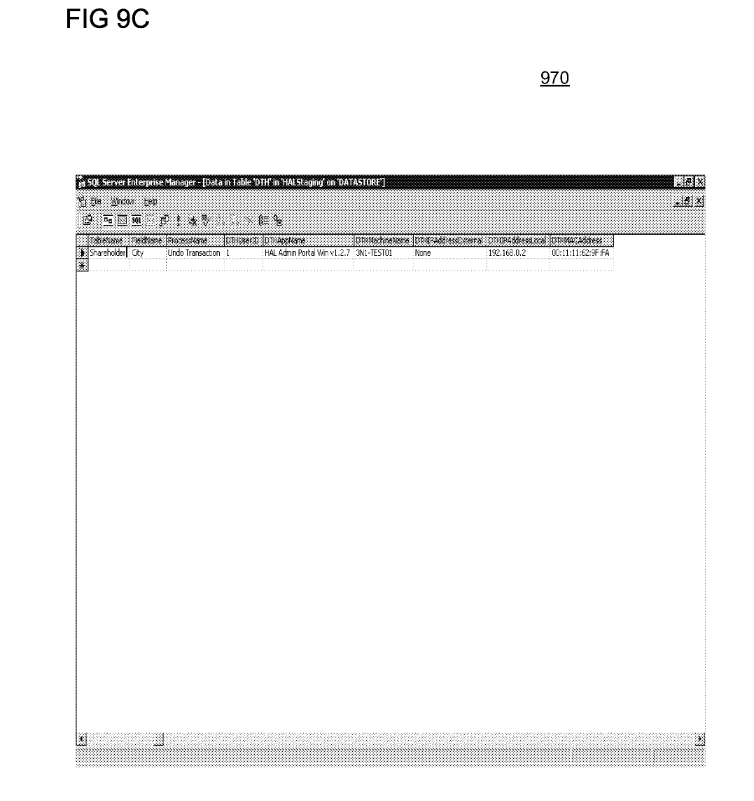

Referring to FIG. 9A, a method for undoing an update to information stored in the application database 150 is illustrated. At step 902, the user initiates a process to undo a previous update made to a data record included in the application database 150. For example, the user interacts with a GUI of a client application 202 to select an “undo update” option to undo updated information stored in the application database 150. An undo update transaction request is generated and communicated to the web service 130 to undo an update to a data record in application database 150 at step 904. The undo update transaction request includes DTH security information 15 and the primary key of the DTH data record being undone. At decision point 906, the web service 130 receives the undo update transaction request and determines whether the user has proper authorization to update the information. If the user is determined unauthorized at decision point 906, the request to undo updated information is denied and a message indicating the denial is transferred to the client computer 105 and shown on the display 210 at step at step 908. Alternatively, if the user is determined authorized at decision point 906, the web service 130 communicates with the application database 150 to pass the DTH security information 15 and the primary key of the DTH data record and executes the undo stored procedure to undo the update to the data record at step 910. (See Appendix A-11). At step 912, the undo stored procedure executes the primary DTH stored procedure and inserts a record into the primary DTH table to record the undo operation. (See Appendix A-2). The typed dataset 120 is communicated to the client application 100 with the updated information and presented to the user at step 914. FIGS. 9B and 9C are scroll left and scroll right screen shots 960, 970, respectively, showing data records created for various fields after the undo update transaction is complete.

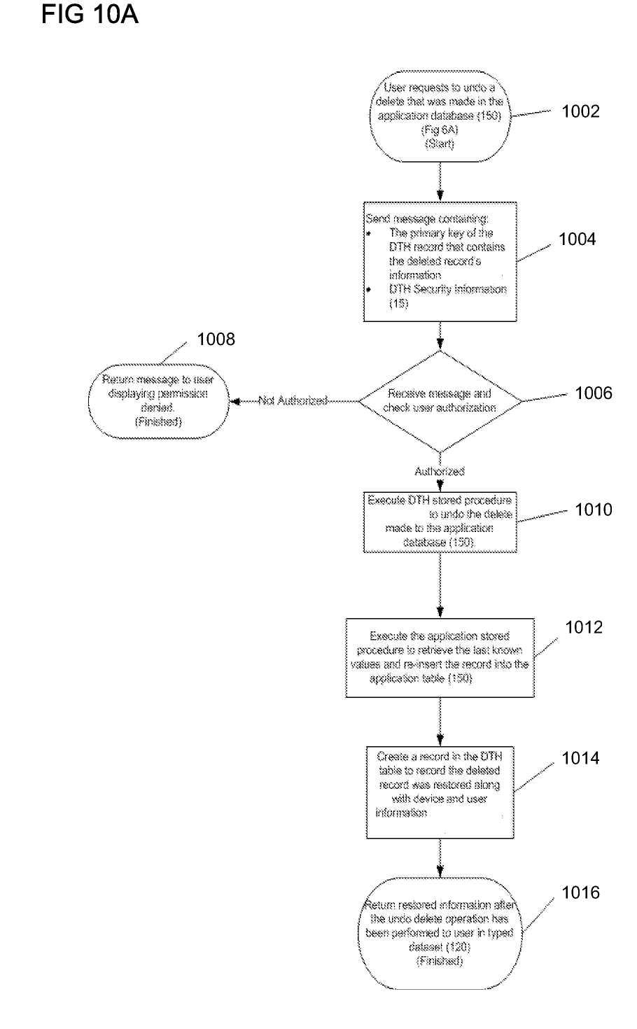

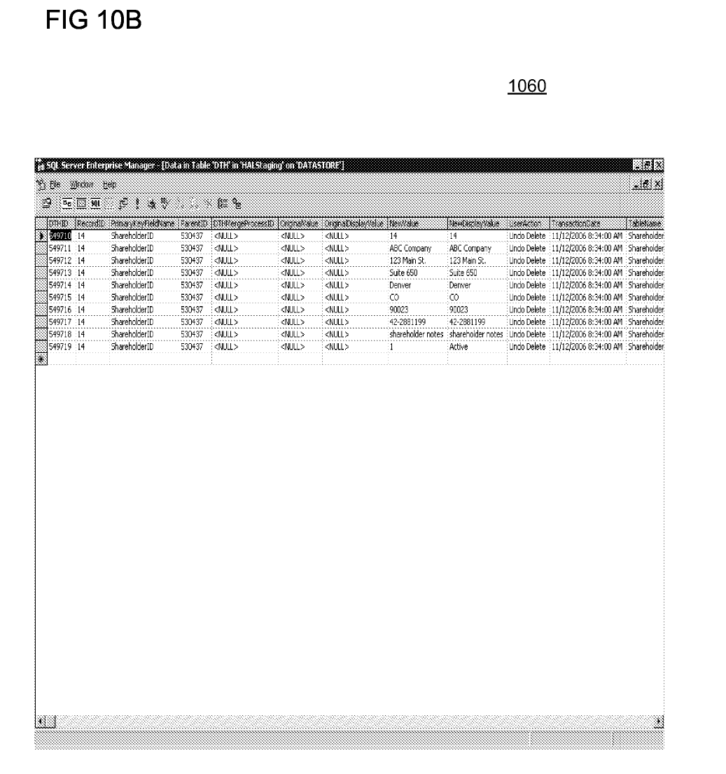

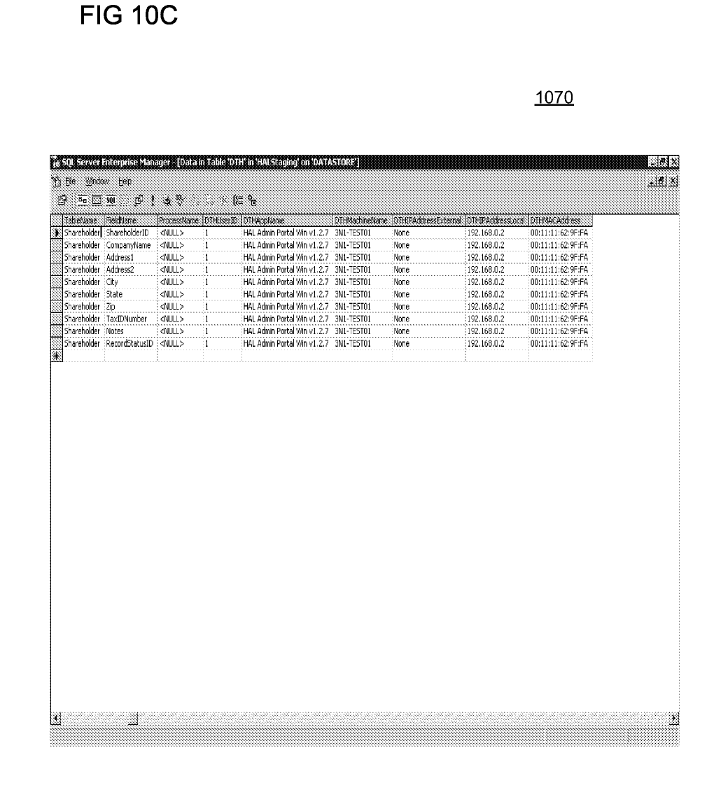

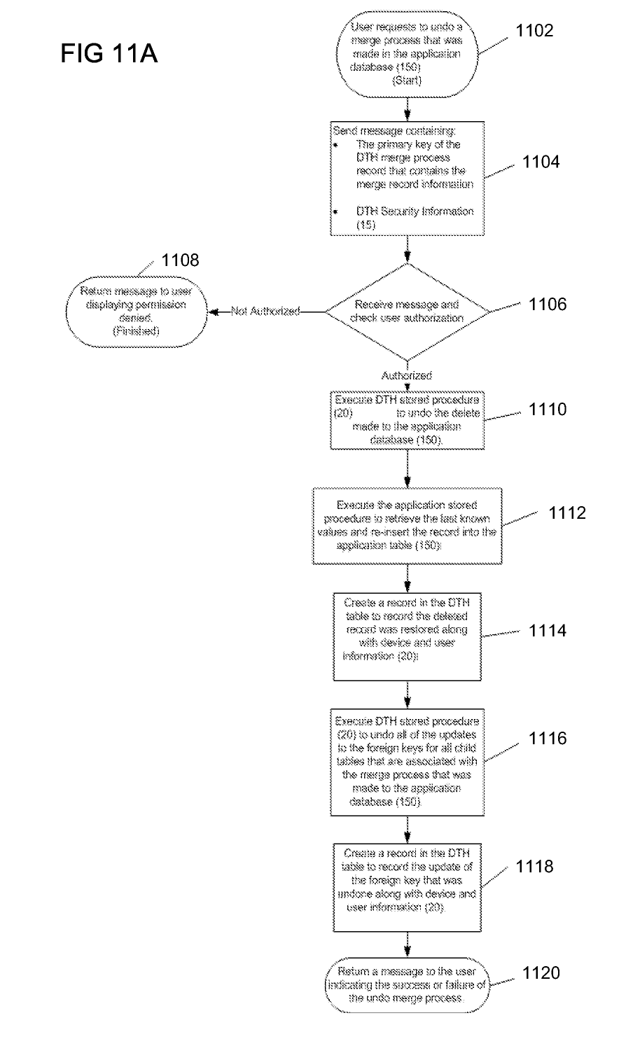

Referring to FIG. 10A, a method for undoing a delete transaction involving data records stored in the application database 150 is illustrated. At step 1002, the user initiates a process to undo a previous deletion made to a data record included in the application database 150. For example, the user interacts with a GUI of a client application 202 to select an “undo delete” option to restore information deleted from the application database 150. An undo delete transaction request is generated and communicated to the web service 130 to undo a deletion of a data record previously included in the application database 150 at step 1004. The undo delete transaction request includes DTH security information 15 and the primary key of the DTH data record to undo. At decision point 1006, the web service 130 receives the undo delete transaction request and determines whether the user has proper authorization to update the information. If the user is determined unauthorized at decision point 1006, the request to undo updated information is denied and a message indicating the denial is transferred to the client computer 105 and shown on the display 210 at step 1008. Alternatively, if the user is determined authorized at decision point 1006, the web service 130 communicates with the application database 150 to pass the DTH security information 15 and the primary key of the DTH data record, and executes the undo stored procedure to undo the delete at step 1010. (See Appendix A-11). At step 1012, the undo stored procedure executes a retrieval stored procedure to retrieve the last known values of the record and re-insert the record into the application database 150. (See Appendix A-12). The undo stored procedure (e.g., see Appendix A-11) executes the primary DTH stored procedure (e.g., see Appendix A-2) and inserts a record into the primary DTH table (e.g., see Appendix A-4) to record the undo delete operation and the values of each field being restored at step 1014. At step 1016, the typed dataset 120 is communicated to the client application with the restored information and presented to the user. FIGS. 10B and 10C are scroll left and scroll right screen shots 1060, 1070, respectively, showing the data records created for various fields after the undo delete transaction is complete.

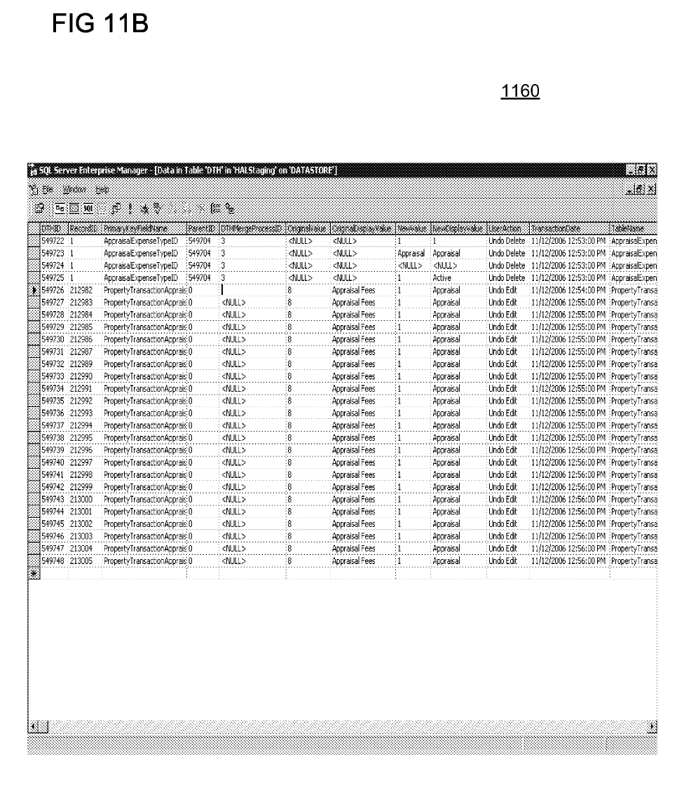

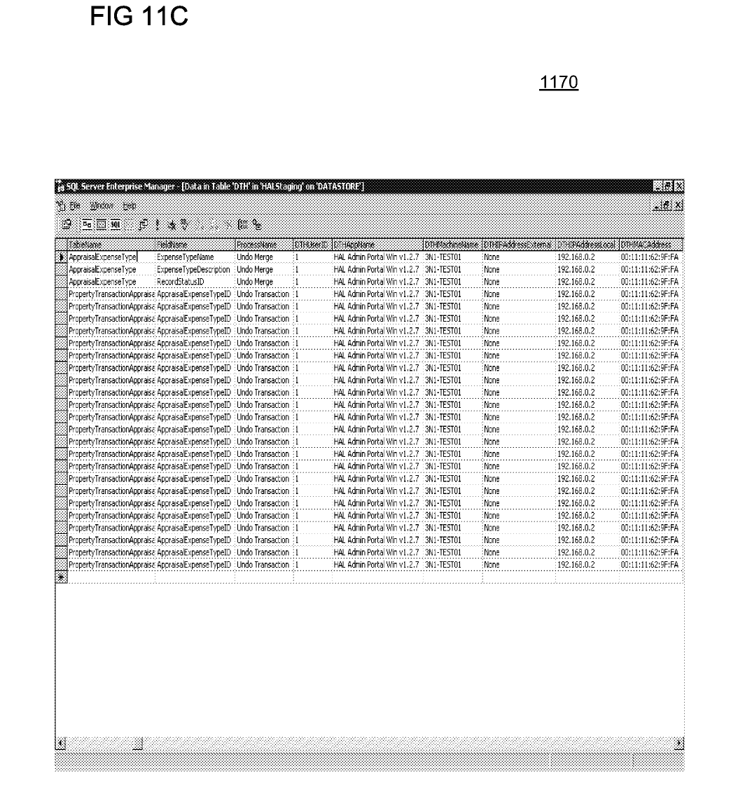

Referring to FIG. 11A, a method for undoing a merge transaction involving data stored in the application database 150 is illustrated. At step 1002, the user initiates a process to undo a merge transaction that involved data records stored in the application database 150. For example, the user interacts with a GUI of a client application 202 to select an “undo merge” option to undo a merge transaction record stored in the application database 150. An undo merge transaction request is generated and communicated to the web service 130 to undo a merge of data records included in the application database 150 at step 1004. The undo merge transaction request includes the primary key of the DTH Merge process record to undo along with the DTH security information 15 and is sent to the web service 130 to undo to the merge process made to the application database 150 at step 1104. At decision point 1106, the web service 130 receives the transaction request and determines whether the user has proper authorization to undo the merge information stored in the database. If the user is determined unauthorized at decision point 1106, the request to undo updated information is denied and a message indicating the denial is transferred to the client computer 105 and shown on the display 210 at step 1108. Alternatively, if the user is determined authorized at decision point 1106, the web service 130 communicates with the application database 150, passing the DTH security information 15) and the primary key of the DTH Merge Process Record (FIG. 7B) and executes the undo stored procedure to undo the deleted record at step 1110. (See Appendix A-11). At step 1112, the undo stored procedure executes a retrieval stored procedure to retrieve the last known values of the record and re-insert the record into the database. (See Appendix A-12). The undo stored procedure then executes the primary DTH insert stored procedure (e.g., see Appendix A-2) and inserts a record into the primary DTH table (FIG. 5C) to record the undo delete operation and the values of each field being restored) at step 1114. At step 1116, the undo stored procedure executes to undo the update of each foreign key that was updated as part of the merge process. The undo stored procedure then executes the primary DTH insert stored procedure and inserts a record into the primary DTH table to record the undo operation at step 1118. At step 1120, a value is communicated to the client application 202 indicating the success or failure of the undo merge process. FIGS. 11B and 11C are scroll left and scroll right screen shots 1160, 1170, respectively, showing the data records created for various fields after the undo delete transaction is complete.

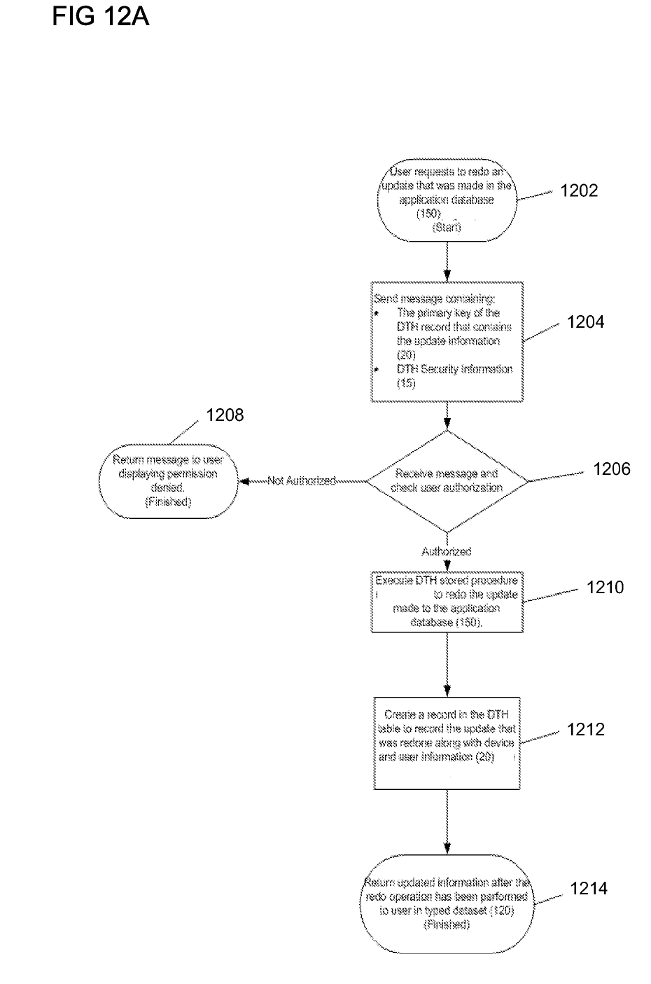

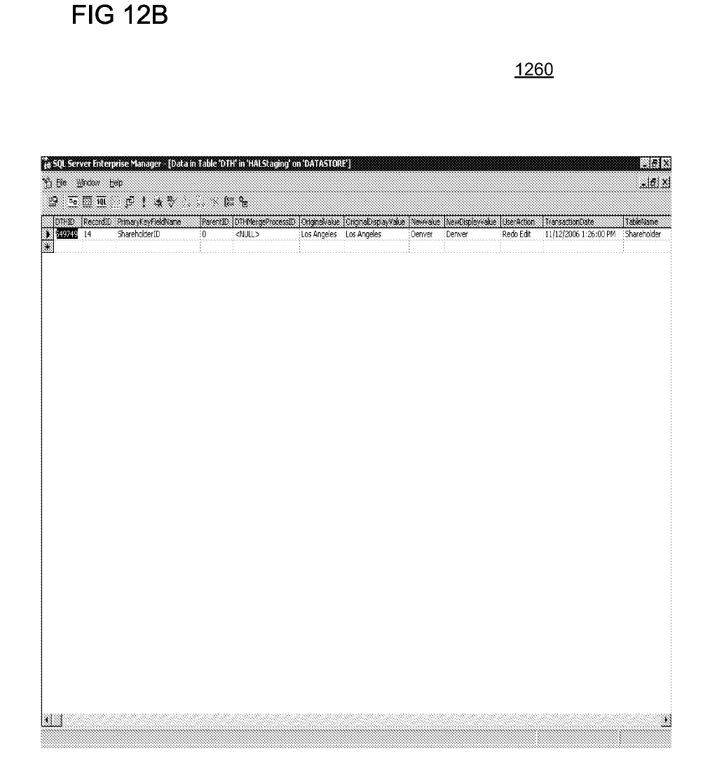

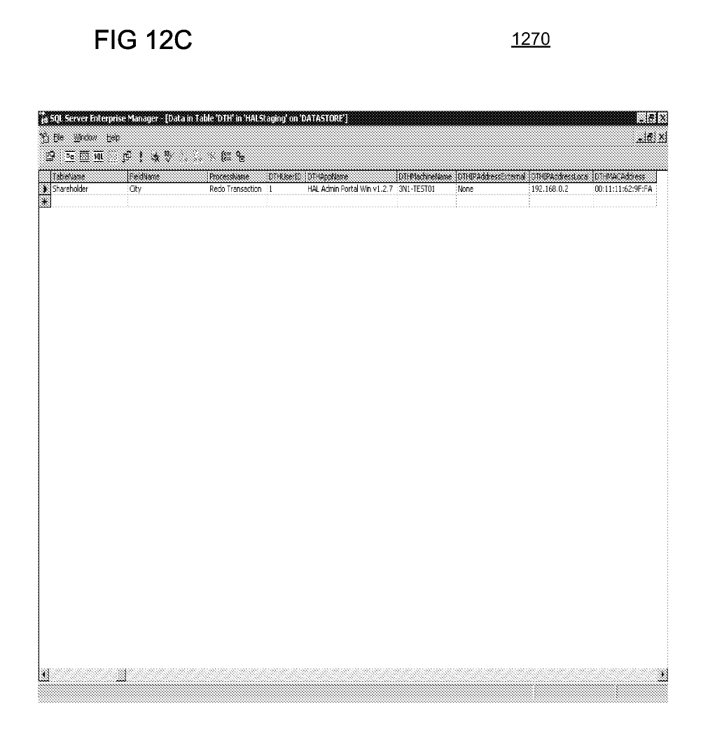

Referring to FIG. 12A, a method for redoing an update transaction involving data stored in the application database 150 is illustrated. Notably redoing an update transaction can be considered undoing an undo update transaction. At step 1202, the user initiates a process to redo an update transaction previously undone. For example, the user interacts with a GUI of a client application 202 to select a “redo update” option to reestablish an update to data record which was previously undone. A redo update transaction request is generated and communicated to the web service 130 to undo redo an update of a data record included in the application database 150 at step 1204. The redo update transaction request includes the primary key of the DTH record to redo along with the DTH security information and is sent to the web service 130 to redo to the update to the application database 150 at step 1204. At decision point 1206, the web service 130 receives redo update transaction request and determines whether the user has proper authorization to redo the update the information. If the user is determined unauthorized at decision point 1206, the request to undo updated information is denied and a message indicating the denial is transferred to the client computer 105 and shown on the display 210 at step 1208. Alternatively, if the user is determined authorized at decision point 1206, the web service 130 communicates with the application database 150 to pass the DTH security information 15 and the primary key of the DTH record (FIG. 5C) and executes a redo stored procedure to redo the update at step 1210. (See Appendix A-13). At step 1212, the redo stored procedure executes the primary DTH insert stored procedure (e.g., see Appendix A-2) and inserts a record into the primary DTH table to record the redo operation. The typed dataset 120 is communicated to the client application with the updated information and presented to the user at step 1214. FIGS. 12B and 12C are scroll left and scroll right screen shots 1260, 1270, respectively, showing the data records created for various fields after the redo update transaction is complete.

The order of execution or performance of the operations in embodiments of the DTH system 10 illustrated and described herein is not essential, unless otherwise specified. That is, the operations may be performed in any order, unless otherwise specified, and embodiments of the DTH system 10 may include additional or fewer operations than those disclosed herein. For example, it is contemplated that executing or performing a particular operation before, contemporaneously with, or after another operation is within the scope of embodiments of the DTH system 10.

Embodiments of the DTH system 10 may be implemented with computer-executable instructions. The computer-executable instructions may be organized into one or more computer-executable components or modules. Aspects of the DTH system may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1-8. (canceled)

9. A computer implemented method for managing a plurality of data transaction records stored in a database linked to a server computer, wherein each of said plurality of data transaction records corresponds to a particular data transaction, and wherein each of said plurality of data transaction records are created in response to a previous transaction request transferred from a client computer to the server computer via a communication network, the method comprising:
receiving, at the server computer, a new transaction request from the client computer, said new transaction request identifying a data transaction record and specifying a desired modification to a data transaction associated with the identified transaction record;
modifying the data transaction associated with the identified transaction record in accordance with the desired modification; and
storing a new data transaction record in the database, said new data transaction record corresponding to the modified data transaction.

10. The computer implemented method of claim 9, wherein the previous transaction request is a select/view transaction request, an insert transaction request, an update transaction request, a delete transaction request, or a merge transaction request.

11. The computer implemented method of claim 9, wherein the new transaction request is an undo transaction request, and wherein the desired modification specified by said undo transaction request is to undo the data transaction associated with the identified transaction record, and wherein an undo transaction record is stored in the database.

12. The computer implemented method of claim 11, wherein the undo transaction request is an undo update transaction request, an undo insert transaction request, an undo delete transaction request, or an undo merge transaction request.

13. The computer implemented method of claim 9, wherein the new transaction request is a redo transaction request, and wherein the desired modification specified by said redo transaction request is to obtain a preceding data transaction record, and wherein a redo transaction record is stored in the database.

14. The computer implemented method of claim 13, wherein the redo transaction request is a redo update transaction request.

15. The computer implemented method of claim 9, wherein the new transaction request further comprises:
information identifying the client computer from which the new transaction request is generated;
information identifying a new transaction type; and
information identifying security details of the user.

16. The computer implemented method of claim 9, wherein storing the new transaction record includes executing one or more stored procedures to facilitate the storage of the new transaction record in the database, and wherein the one or more stored procedures are executed based on the information identifying the new transaction type.

17. The computer implemented method of claim 9, wherein storing the new transaction record includes storing records in a data transaction history (DTH) table, said DTH table having various fields for storing different types of information corresponding to a particular transaction data record.

18. A system for managing a plurality of data transaction records stored in a database, wherein each of said plurality of data transaction records corresponds to a particular data transaction, the system comprising:
a client computer generating a transaction request, said transaction request identifying a data transaction record in the plurality of transaction records and specifying a desired modification to a data transaction associated with the identified transaction record;
a server computer linked to the client computer via a communication network for receiving the transaction request;
wherein the server computer is responsive to the received transaction request to execute a DTH application to modify the data transaction associated with the identified data transaction record in accordance with the desired modification; and
wherein the server computer stores a new data transaction record in the database, said new data transaction record corresponding to the modified data transaction.

19. The system of claim 18, wherein the undo transaction request is an undo update transaction request, an undo insert transaction request, an undo delete transaction request, or an undo merge transaction request.

20. The system of claim 18, wherein the redo transaction request is a redo update transaction request.

21. The system of claim 18, wherein the new transaction request further comprises:
information identifying the client computer from which the new transaction request is generated;
information identifying a new transaction type; and
information identifying security details of the user.

22. The system of claim 18, wherein the DTH application includes one or more stored procedures to facilitate the storage of the new transaction record in the database, and wherein the one or more stored procedures are executed based on the information identifying the new transaction type.

23. The system of claim 18, wherein the server computer stores the new transaction record includes storing records in a data transaction history (DTH) table, said DTH table having various fields for storing different types of information corresponding to a particular transaction data record.

24. A computerized system having computer executable components for allowing a user to initiate a new transaction by interacting with a plurality of data transaction records stored in a database linked to a server computer, wherein each of said plurality of data transaction records corresponds to a particular data transaction, and wherein each of said plurality of data transaction records are created in response to a previous transaction request transferred from a client computer to the server computer via a communication network, said computerized system comprising:
a transaction component for identifying specific transaction information included in a new transaction request received from the client computer, and wherein the computerized system modifies a data transaction associated with the identified data transaction record in accordance with the desired modification; and
a storage component for storing the identified specific transaction information in the database.

25. The computerized system of claim 24 wherein the new transaction request is an undo update transaction request, an undo insert transaction request, an undo delete transaction request, an undo merge transaction request, or a redo update request.

26. The computerized system of claim 24 further including a server UI component for transferring the plurality of data transaction records to the client computer for display to a user via a graphical user interface, and wherein the user selects at least one of the plurality of data transaction records being displayed via the a graphical user interface and a desired transaction to generate the new transaction request.

27. The computerized system of claim 24 further including a security component for identifying device information corresponding to the client computer and for transferring the identified device information from the client computer to the server computer.

28. The computerized system of claim 27, wherein the storage component executes stored procedures to combine the identified device information with the identified specific transaction information for storage in a data table as a new data transaction record within the database.
